(19) United States
(12) Patent Application Publication
(10) Pub. No.: US 2014/0206235 A1
(43) Pub. Date: Jul. 24, 2014

(54) CONNECTOR ASSEMBLY

(71) Applicants: HON HAI PRECISION INDUSTRY CO., LTD., New Taipei (TW); HONG FU JIN PRECISION INDUSTRY (Wu-Han) CO., LTD., Wuhan (CN)

(72) Inventors: ZHI-YONG GAO, Wuhan (CN); YU-LIN LIU, Wuhan (CN)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/051,758

(22) Filed: Oct. 11, 2013

(30) Foreign Application Priority Data
Jan. 19, 2013 (CN) 2013100190270

(51) Int. Cl. H01R 12/72

(52) U.S. Cl. CPC H01R 12/72
USPC 439/630

(57) ABSTRACT

A connector assembly includes a first connector and a second connector. The first connector includes a receiving case. A contacting piece and a movable contacting point are received in the first connector. The contacting piece includes a stationary contacting point. The second connector includes a contacting strip. The second connector matches the first connector, so the contacting strip contacts the contacting piece and moves the movable contacting point to electrically connect to the stationary contacting point.

### BACKGROUND

1. Technical Field

The present disclosure relates to connector assemblies, and particularly to a connector assembly having a safety apparatus.

2. Description of Related Art

Connectors are widely used in electronic devices to transmit signals. For transmitting different signals, the electronic device often uses different connectors. Each connector transmits one kind of signal. However, inserting a wrong connector in the electronic device could damage the connector and device.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of a connector assembly.

FIG. 2 is similar to FIG. 1, but viewed from another aspect.

FIG. 3 is a partially assembled view of the connector assembly of FIG. 1.

FIG. 4 is a cross-sectional view of the connector assembly of FIG. 3 taken along line VI-VI.

FIG. 5 is another cross-sectional view of the connector assembly showing the connector assembly being assembled.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

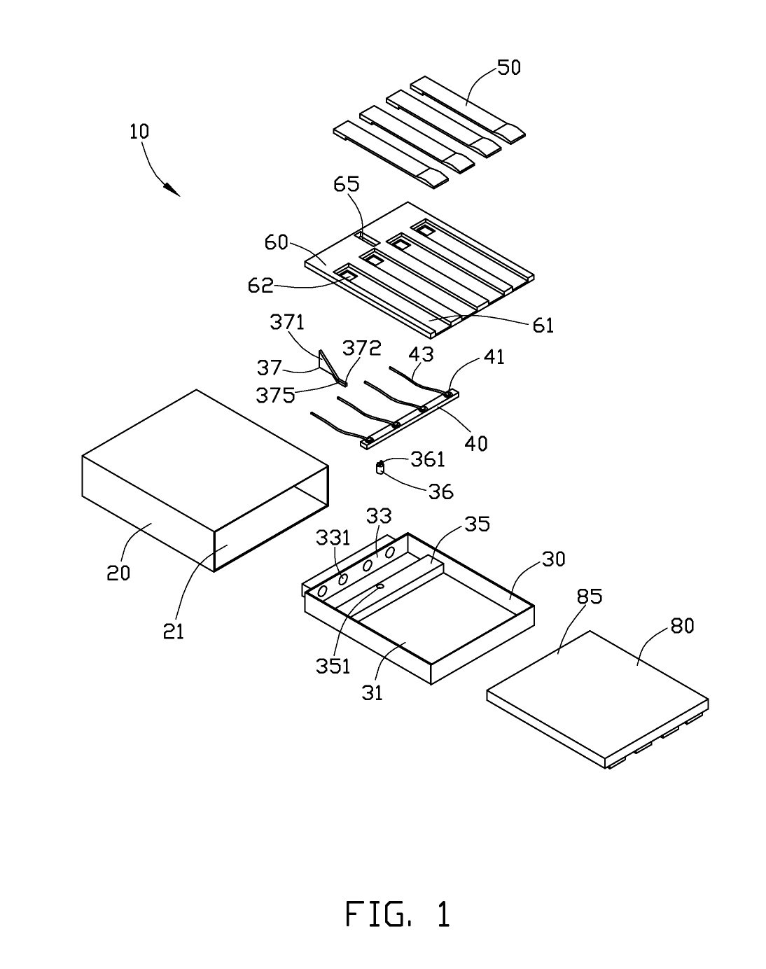

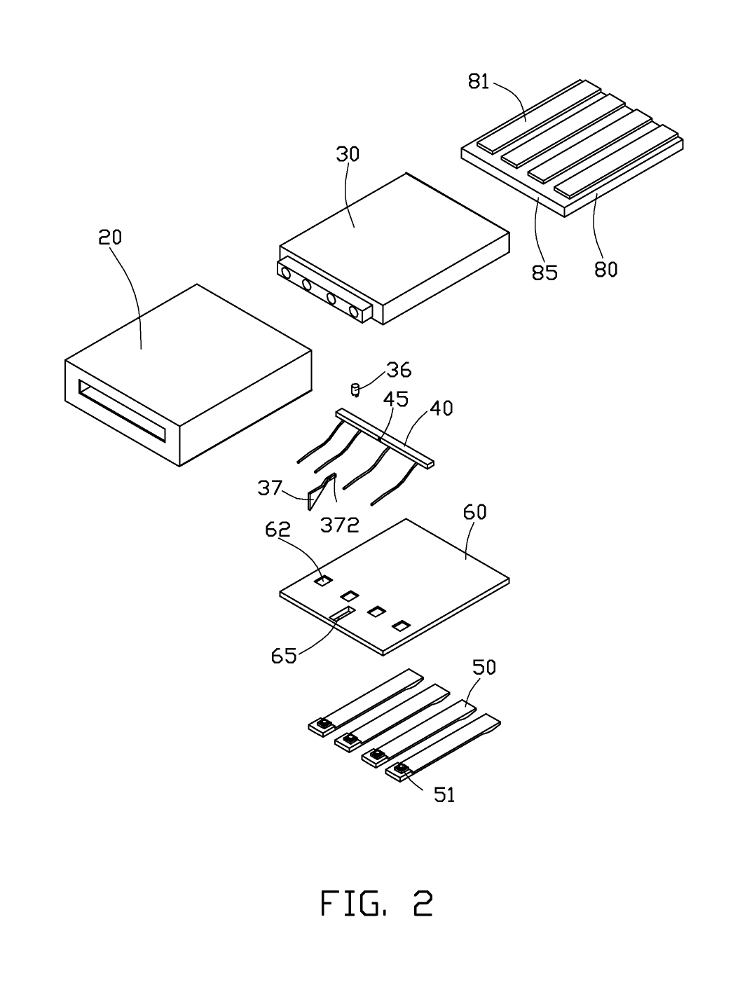

FIGS. 1 and 2 show an embodiment of a connector assembly. The connector assembly includes a first connector 10 and a second connector 80 adapted to connect with the first connector 10. The first connector 10 includes an enclosure 20, a receiving case 30, a base strip 40, a plurality of contacting pieces 50, and a securing board 60. The enclosure 20 is substantially hollow and defines an accommodating space 21.

The receiving case 30 includes a bottom plate 31 and a rear plate 33. A supporting piece 35 is mounted on the bottom plate 31. The supporting piece 35 includes a receiving hole 351. The rear plate 33 defines a plurality of wiring holes 331. A supporting member 36 is placed in the receiving hole 351. The supporting member 36 includes a pivot shaft 361. A driving member 37 is pivotally mounted to the supporting member 36. The driving member 37 includes a driving piece 371 and an inserting end 372. The driving piece 371 is substantially triangular, and the inserting end 372 is located adjacent to a corner of the driving piece 371. The driving member 37 defines a pivot hole 375 between the driving piece 371 and the inserting end 372.

The base strip 40 is mounted on the driving member 37. A plurality of movable contacting points 41 is located on the base strip 40. Each movable contacting point 41 is connected to a wire 43. The base strip 40 defines an inserting hole 45 for receiving the inserting end 372 of the driving member 37.

The securing board 60 is secured on a top portion of the receiving case 30. The securing board 60 defines a plurality of receiving slots 61. The securing board 60 defines an opening 62 in each receiving slot 61. The securing board 60 defines a slit 65 for receiving the driving piece 371 of the driving member 37. Each receiving slot 61 receives one contacting piece 50. The contacting piece 50 includes a stationary point 51.

The movable contacting points 41, the stationary points 51, and the contacting pieces 50 are made of conducting material.

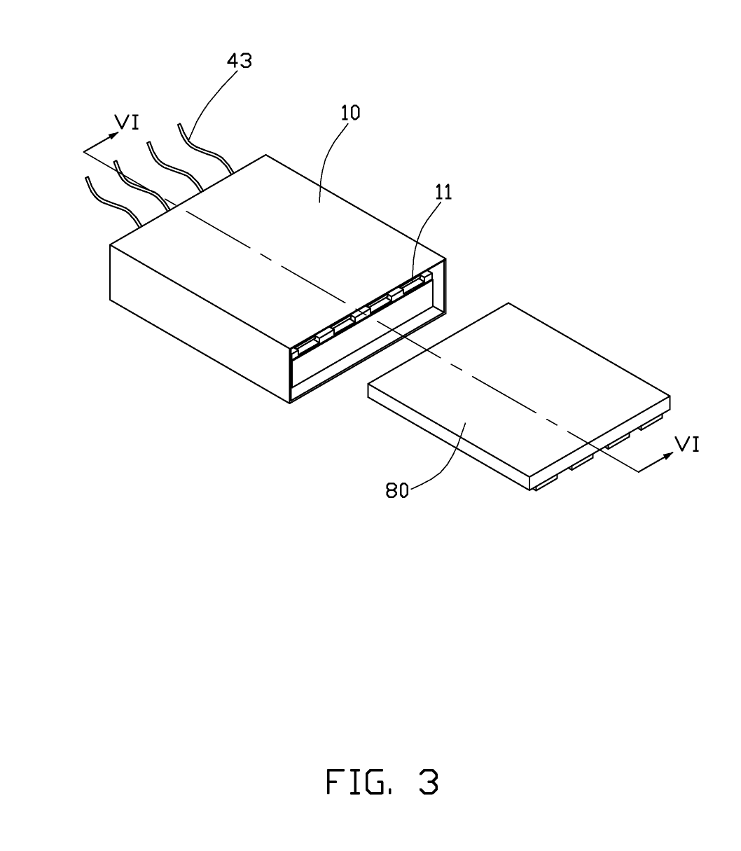

Referring to FIGS. 1 to 3, in assembly of the first connector 10, the supporting member 36 is received in the receiving hole 351 of the supporting member 36. The pivot shaft 361 of the supporting member 36 projects out of the receiving hole 351. The pivot shaft 361 is received in the pivot hole 375 of the driving member 37 to pivotally mount the driving member 37 to the supporting member 36. The inserting end 372 is then received in the inserting hole 45 of the base strip 40 to secure the driving member 37 and the base strip 40 together. Each wire 43 of the base strip 40 extends out of a corresponding wiring hole 331 of the receiving case 30.

In succession, each of the plurality of contacting pieces 50 is received in a corresponding receiving slot 61 of the securing board 60, such that the stationary contacting points 51 project out of the opening 62. The securing board 60 is placed above the supporting piece 35, and a bottom portion of the securing board 60 is secured on the receiving case 30. The driving piece 371 is received in the slit 65 of the securing board 60. The receiving case 30 and the securing board 60 are then received in the accommodating space 21 of the enclosure 20 and secured in the enclosure 20, thereby completing assembly of the first connector 10. A gap 11 is defined above the securing board 60 in the enclosure 20.

The second connector 80 includes a plurality of contacting strips 81 corresponding to the plurality of contacting pieces 50. A front portion of the second connector 80 forms a pushing portion 85. The second connector 80 is received in the gap 11 to connect with the first connector 10.

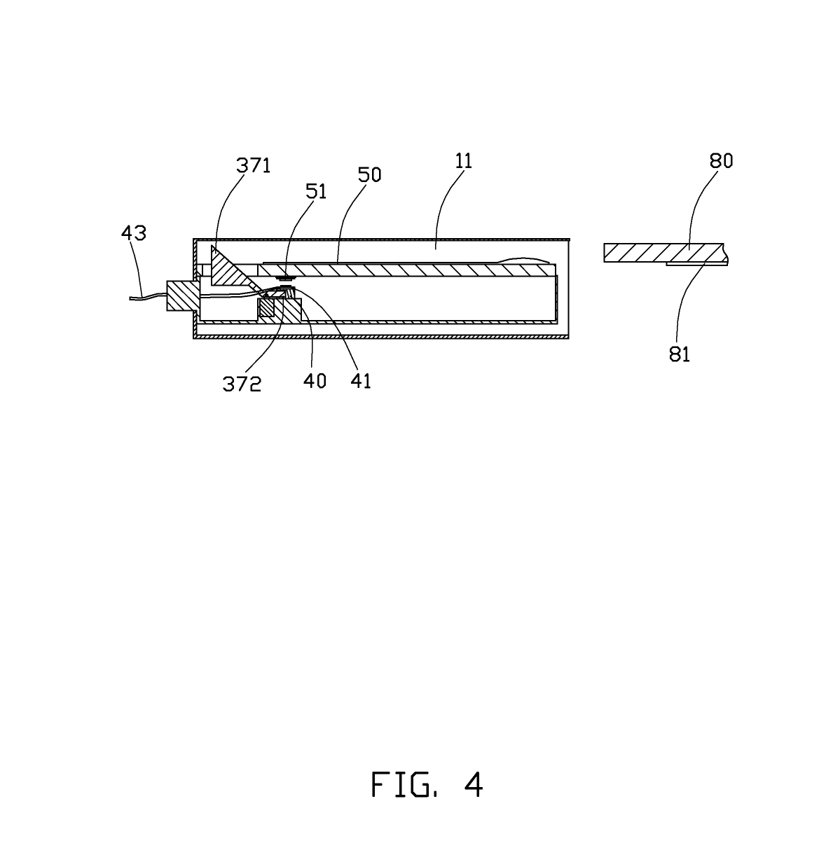

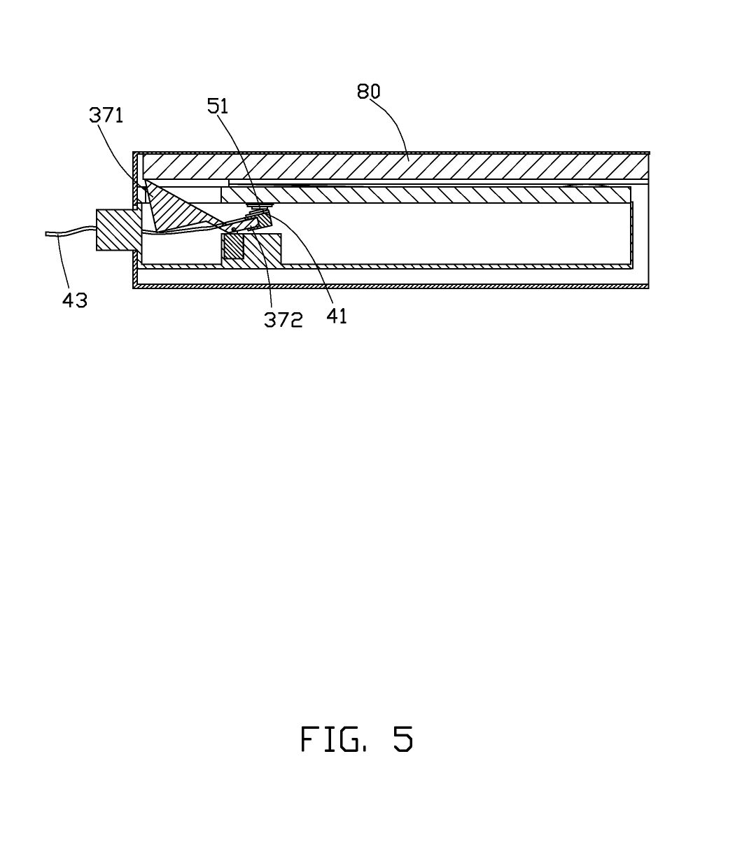

Referring to FIGS. 4 and 5, when the second connector 80 is received in the gap 11 of the first connector, the contacting strips 81 of the second connector 80 electrically connect to the contacting pieces 50 of the first connector. The pushing portion 85 pushes the driving piece 371 to rotate the driving member 37. When the driving member 37 rotates, the inserting end 372 of the driving member 37 pushes the base strip 40 to move upward, causing the movable contacting points 41 to contact the stationary contacting points 51 of the contacting pieces 50. Therefore, an electrical connection between the first connector 10 and the second connector 80 is achieved.

When an unmatched connector is received in the first connector 10, the movable contacting points 41 and the stationary contacting points 51 do not contact each other to prevent the unmatched connector from electrically connecting to the first connector.

It is to be understood, however, that even though numerous characteristics and advantages of the embodiments have been set forth in the foregoing description, together with details of the structure and functions of the embodiments, the disclosure is illustrative only, and changes may be made in detail, especially in the matters of shape, size, and arrangement of parts within the principles of the present disclosure to the full extent indicated by the broad general meaning of the terms in which the appended claims are expressed.

What is claimed is:

1. A connector assembly, comprising:
a first connector comprising a receiving case, a contacting piece received in the receiving case, and a movable contacting point received in the receiving case, the contacting piece comprising a stationary contacting point;
a second connector comprising a contacting strip;
wherein the second connector is configured to match the first connector to contact the contacting strip with the contacting piece and move the movable contacting point to contact the stationary contacting point.

2. The connector assembly of claim 1, wherein the first connector further comprises a driving member pivotally mounted in the receiving case, the driving member comprises a driving member body, a driving piece located on one end of the driving member body, and an inserting end located on another end of the driving member body, the inserting end is mounted with the movable contacting point, and the second connector is configured to push the driving piece to move the inserting end and the movable contacting point.

3. The connector assembly of claim 2, further comprising a base strip, wherein the movable contacting point is located on the base strip, the base strip defines an inserting hole, and the inserting end of the driving member is inserted in the inserting hole.

4. The connector assembly of claim 2, wherein the second connector comprises a pushing portion configured to push the driving piece.

5. The connector assembly of claim 2, wherein the first connector further comprising a securing board, wherein the contacting piece is mounted on the securing board, the securing board defines a slit, and the driving piece is inserted in the slit.

6. The connector assembly of claim 5, wherein the securing board further defines a receiving slot and an opening in the receiving slot, the contacting piece is located in the receiving slot, and the stationary contacting point is inserted through the opening.

7. The connector assembly of claim 2, further comprising a support member, wherein the receiving case defines a receiving hole, the supporting member is located in the receiving hole, the supporting member comprises a pivot shaft, the driving member body defines a pivot hole located between the driving piece and the inserting portion, and the pivot shaft is pivotally mounted in the pivot hole.

8. The connector assembly of claim 1, wherein the movable contacting point is connected to a wire, the receiving case defines a wiring hole, and the wire is inserted through the wiring hole.

9. A connector, comprising:
a receiving case comprising a bottom plate and a supporting piece mounted on the bottom plate;
a driving member comprising a driving piece and an inserting end, the driving member pivotally mounting on the supporting piece between the driving piece and the inserting end;
a base strip mounted with the inserting end;
a movable contacting point located on the base strip; and
a contacting piece comprising a stationary contacting point aligned to the movable contacting point;
wherein the driving piece is configured to be pushed to rotate the driving member to move the movable contacting point to contact the stationary contracting point.

10. The connector of claim 9, further comprising a supporting member, wherein the supporting piece defines a receiving hole, the supporting member is located in the receiving hole, the supporting member comprises a pivot shaft, the driving member defines a pivot hole located between the driving piece and the inserting portion, and the pivot shaft is pivotally mounted in the pivot hole.

11. The connector of claim 9, wherein the base strip defines an inserting hole, and the inserting end of the driving member is inserted in the inserting hole.

12. The connector of claim 9, further comprising a securing board, wherein the contacting piece is mounted on the securing board, the securing board defines a slit, and the driving piece is inserted in the slit.

13. The connector assembly of claim 12, wherein the securing board further defines a receiving slot and an opening in the receiving slot, the contacting piece is located in the receiving slot, and the stationary contacting point is inserted through the opening.

14. The connector assembly of claim 9, wherein the movable contacting point is connected to a wire, the receiving case defines a wiring hole, and the wire is inserted through the wiring hole.
